(19) United States
(12) Patent Application Publication
(10) Pub. No.: US 2003/0225845 A1
(43) Pub. Date: Dec. 4, 2003

(54) Method of providing multicast service and server employing the method

(75) Inventor: Jin-Woo Hong, Suwon-city (KR)

Correspondence Address: SUGHRUE MION, PLLC, 2100 PENNSYLVANIA AVENUE, N.W., WASHINGTON, DC, 20037, US

(73) Assignee: SAMSUNG ELECTRONICS CO., LTD.

(21) Appl. No.: 10/446,048

(22) Filed: May 28, 2003

(30) Foreign Application Priority Data
May 28, 2002 (KR) 2002-0029689

(51) Int. Cl. G06F 15/16

(52) U.S. Cl. 709/206

(57) ABSTRACT

Disclosed is a method of providing multicast service and a server employing the method. The server employing the method of providing the multicast service comprises a transceiver and a control unit. The transceiver transceives data from a plural number of clients. The control unit converts the format in which a particular service is requested into a multicast format and provides the service to all the clients that requested the service, when unicast service request signals with respect to the particular service are received from the clients. According to such multicast service providing method and the server employing the method thereof, the service can be provided regardless of a limited bandwidth of the server, even when the requests concurrently made by the clients exceed the service limit.

This application claims the priority of Korean Patent Application No. 2002-0029689, filed May 28, 2002 in the Korean Intellectual Property Office, which is incorporated herein in its entirety.

### BACKGROUND OF THE INVENTION

1. Field of the Invention

The present invention relates to a server providing service on the Internet, and more particularly, to a method of providing multicast service by gathering the service requested in a unicast format, converting the format into a multicast format, and providing the service in the multicast format.

2. Description of the Prior Art

FIG. 1 is a drawing showing a conventional server providing service to a plurality of clients in a unicast format.

The server 10 providing service via the Internet is connected with the plural number of clients 22, 24, 26, and 28 through a router 20.

Conventionally, when requests are made by a client among the clients 22, 24, 26, and 28, the server 10 provides service in the unicast format for the requests.

The server also provides unicast service for requests occurring concurrently with respect to the same contents.

For example, if a content is to be serviced in 100 kbps and 100 clients simultaneously request service for that content, the server 10 makes a unicast connection for each of the 100 clients, and uses a service bandwidth of 100×100 kbps=10 Mbps.

Therefore, it becomes problematic because if the number of clients requesting service exceeds the limit of the bandwidth, the server 10 cannot provide service.

### SUMMARY OF THE INVENTION

An object of the invention is to solve at least the above problem and/or disadvantage and to provide at least the advantages described hereinafter.

Accordingly, one object of the present invention is to solve the foregoing problems by providing a method of providing multicast service and a server employing the method wherein the same service is gathered, a unicast format in which the service is requested is converted into a multicast format, and the service is provided in the multicast format when the same service is requested by a plurality of clients in the unicast format.

The foregoing and other objects and advantages are realized by providing a server comprising a transceiver transceiving data with a plurality of clients, and a control unit converting the format in which a particular service is requested into a multicast format and providing the service to all clients who requested the service, when unicast service request signals with respect to the particular service are received from two or more clients.

The control unit comprises a converting list and a converting unit. The converting list lists clients by requested service and records service requests when unicast service is requested by the clients. The converting unit converts a unicast format in which service is requested into the multicast format, when more than a predetermined number of unicast service requests are recorded in the converting list for a particular service.

The control unit further comprises a timer for setting a predetermined time. The control unit operates the timer when unicast service is initially requested, and counts a number of service requests stored in the converting list when the predetermined time set in the timer has passed.

The converting unit converts the format in which the service is requested into the multicast format when the number of unicast service requests is 2 or more per service.

Another object of the present invention is to solve the foregoing problems by providing a method of providing multicast service to a plural number of clients, wherein a unicast format in which a particular service is requested is converted into a multicast format, and the service is provided to all the clients that requested the service, when a unicast service request signal for the particular service is received from two or more clients.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings wherein:

FIG. 1 is a drawing showing a conventional server providing service to the plural number of clients in a unicast format;

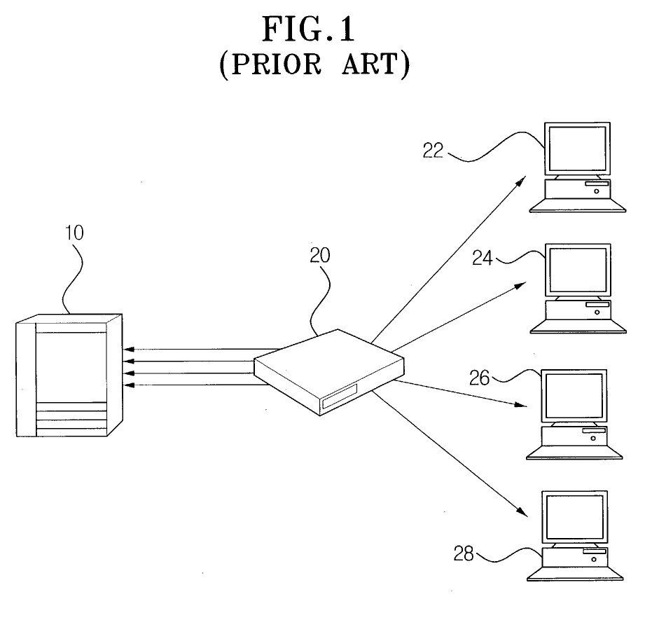

FIG. 2 is a block diagram showing a server according to the present invention;

FIG. 3 is a flow chart showing a method of providing multicast service according to the present invention; and

FIG. 4 is a drawing showing a server providing service to the plural number of clients in a multicast format according to the present invention.

### DETAILED DESCRIPTION OF AN EXEMPLARY EMBODIMENT

The following detailed description will present a method for providing multicast service and a server employing the method according to an illustrative, non-limiting embodiment of the invention in reference to the accompanying drawings.

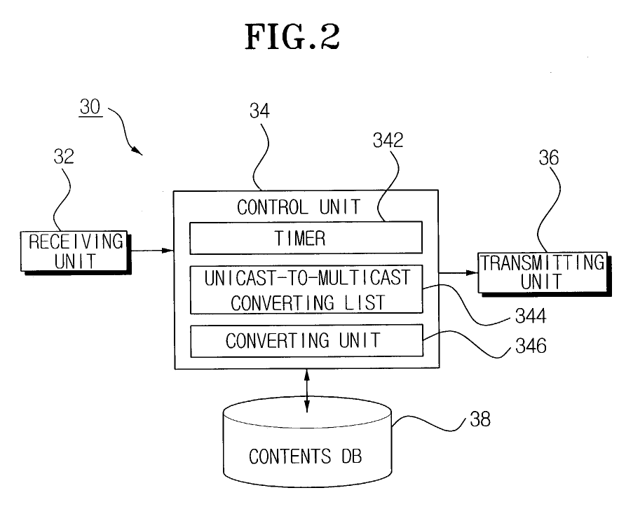

FIG. 2 is a block diagram showing a server according to the present invention.

A server 30 comprises a receiving unit 32, a control unit 34, a transmitting unit 36, and a contents database 38.

The server 30 receives service request signals through the receiving unit 32 from at least one client connected to the server via the Internet.

Also, the server 30 provides corresponding service requested by clients through the transmitting unit 36.

The contents corresponding to the service provided by the server 30 are databased and stored in the contents database 38.

The control unit 34 comprises a unicast-to-multicast converting list 344, and a converting unit 346.

When the unicast service is initially requested, a timer 342 set for a predetermined time starts.

When the unicast service is requested by clients, the control unit 34 lists the clients by the requested service and records the requests in the unicast-to-multicast converting list 344.

The converting unit 346 converts the unicast format in which the service is requested into a multicast format.

The control unit 34 identifies the number of unicast service requests recorded in the unicast-to-multicast converting list 344 after the time set in the timer 342 has passed.

When more than a predetermined number, for example 2, of unicast service requests for a particular service are recorded, the converting unit 346 controls to convert a unicast format in which the service is requested into a multicast format.

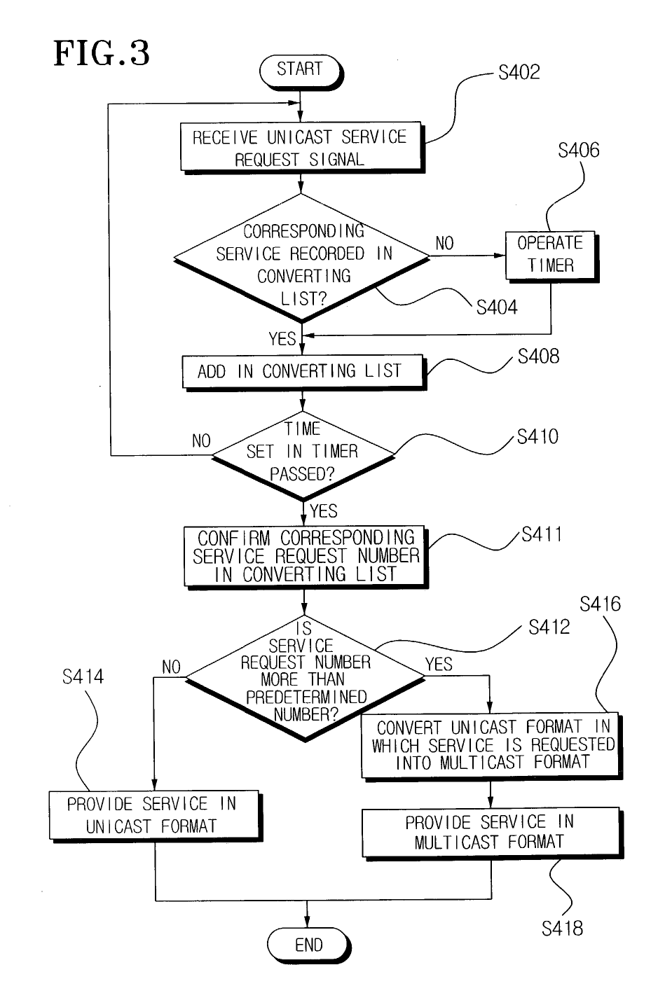

FIG. 3 is a flow chart showing a method of providing multicast service according to the present invention.

When the server 30 receives service request signals in a unicast format from a particular client (S402), the server 30 confirms if the requested service is recorded in the unicast-to-multicast converting list 344 (S404).

If the requested service is recorded in the unicast-to-multicast converting list 344, that means unicast service is already requested by another client.

However, if the requested service is not recorded in the unicast-to-multicast converting list 344, it means no other client has requested the service in the unicast format, and therefore the timer 342 is operated (S406) and the requested service is added to the unicast-to-multicast converting list 344 (S408).

When the time set in the timer has passed (S410), the number of service requests in the converting list is identified (S411).

If the number of the requested service in the converting list is below a predetermined number, for example 1 (S412), the service is provided in a unicast format (S414).

If the number of the requested service in the converting list is above the predetermined number, for example 2, the format is converted from the unicast into the multicast (S416), and the requested service is provided in the multicast format (S418).

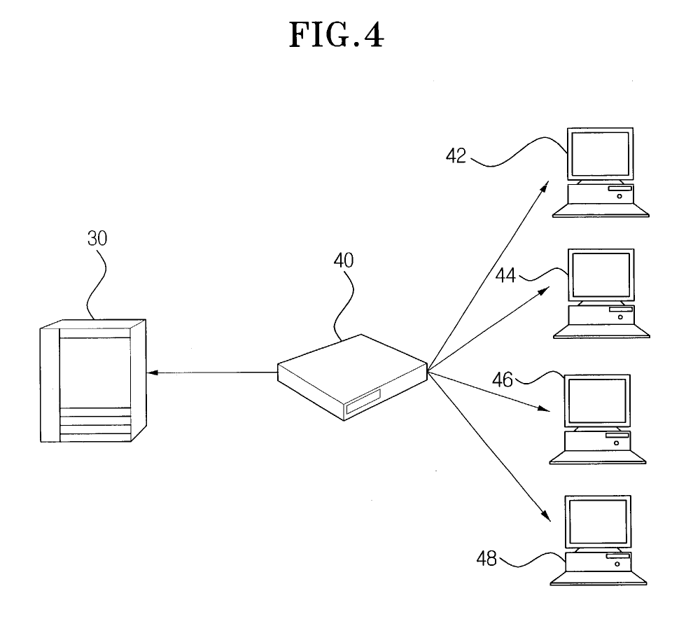

FIG. 4 is a drawing showing a server providing service to a plurality of clients in a multicast format, according to the present invention.

The server 30 providing service via the Internet is connected with the plurality of clients 42, 44, 46, and 48 through the router 40.

Conventionally, when a service request is made by a client among these clients, the server 30 provides service in the multicast format upon request.

Therefore, even when content should be serviced in 100 kbps and 100 clients request service concurrently for that content, the server 30 can provide the service using the 100 kbps service bandwidth to all clients by creating multicast connections.

According to the present invention, the same service is provided after being gathered and converted into the multicast service, and therefore, the service can be provided regardless of the limited bandwidth of the server, even when the requests concurrently made by clients exceed the service limit.

The invention has been shown and described with reference to certain exemplary embodiments thereof, and it will be understood by those skilled in the art that various changes in form and details may be made therein without departing from the spirit and scope of the invention as defined by the appended claims.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A server comprising:
a transceiver transceiving data with a plurality of clients; and
a control unit converting a unicast format in which a service is requested into a multicast format and providing the service to all of the clients that requested the service, when unicast service request signals for the service are received from at least two of the clients.

2. The server according to claim 1, wherein the control unit comprises:
a converting list listing each of the clients requesting unicast service by requested service and recording each unicast service request; and
a converting unit converting the unicast format in which service is requested into the multicast format when more than a predetermined number of unicast service requests are recorded in the converting list for the service.

3. The server according to claim 1, wherein the control unit further comprises a timer for setting a predetermined time, and
wherein the control unit operates the timer when unicast service is initially requested, and counts a number of unicast service requests stored in the converting list when the predetermined time set in the timer lapses.

4. The server according to claim 2, wherein the converting unit converts the unicast format in which the service is requested into the multicast format when the number of unicast service requests for the service is at least two.

5. A method of providing multicast service to a plurality of clients, comprising:
receiving a unicast service request signal for a particular service from at least one of the clients;
converting a unicast format in which the particular service is requested into a multicast format; and
providing the particular service to each client from which the unicast service request signal was received.

6. The method of providing multicast service according to claim 5, further comprising listing the clients by requested service and recording the unicast service request signals, when unicast service is requested by the clients.

7. The method of providing multicast service according to claim 5, further comprising:
operating a timer when a unicast service request for the service is received for the first time; and
counting a number of unicast service requests for the service in a corresponding client list, when a predetermined time in the timer lapses.

8. The method of providing multicast service according to claim 5, wherein the unicast format in which the service is requested is converted into the multicast format when a number of unicast service requests for the service is at least 2.
